(19) United States
(12) Patent Application Publication
(10) Pub. No.: US 2015/0149081 A1
(43) Pub. Date: May 28, 2015

(54) Methods for Enhancing the Display of Electronic Nautical Charts with Depths Corrected for Tide

(71) Applicant: Oscar L. Kramer, JR., Miami Beach, FL (US)

(72) Inventor: Oscar L. Kramer, JR., Miami Beach, FL (US)

(21) Appl. No.: 14/088,310

(22) Filed: Nov. 22, 2013

(51) Int. Cl. G01C 21/20

(52) U.S. Cl. CPC G01C 21/20
USPC 701/450

(57) ABSTRACT

A collection of related methods are claimed for enhancing the display of electronic nautical charts as viewed within an electronic chart display system by correcting the charted depth values for the effects of tide, and displaying actual depths and derivative graphical information, for a specified date and time. Height clearances are similarly adjusted. This will enable new features within the electronic chart display system that will greatly facilitate navigating coastal waters affected by tide. The method is implemented as a computer program.

### FIELD OF THE ART

This processing method pertains to the fields of hydrography, bathymetry and marine navigation. As a data processing method, it also pertains to the field of computer software programming. More specifically, this method pertains to the field of marine cartography. More specifically, this method pertains to the field of electronic nautical chart display systems design and development. It is primarily intended for incorporation into ECDS equipment used by recreational boaters and professional mariners.

### BACKGROUND

These methods address the difficulty of interpreting depth and height clearance information on electronic nautical chart displays in areas with tidal variation. All nautical charts, both in paper and electronic form, present depth and height information relative to some vertical datum related to sea level. In the case of depth readings, the Lowest Astronomical Tide (LAT) is usually used (though not exclusively). Height clearances of bridges, overhead cables, and the like, usually are referenced to Highest Astronomical Tide (HAT). Due to the static nature of the information, the chart producers necessarily choose the datums that result in conservative numbers for depths and height clearances. When a vessel operator needs to take tidal effects into account while navigating or planning a route, the process can be tedious and error prone. When electronic chart display systems (ECDS, including chart-plotters) are used, operators often simply rely on the chart's easily interpreted static color coding to convey depth. It is much easier to keep the vessel's position icon outside of a color-region than it is to read numbers on a display and add tide and draft offsets along the route. Since the color coding and depth contours on static charts are based on low tide and is independent of the vessel's draft, this scheme of navigating is either overly conservative, or in the case of deep draft vessels, inadequate and risky. While taking an overly conservative route seems to be a reasonable option for shallower draft vessels, it can in fact create problems when the operator is forced to navigate unnecessarily longer distances:
It could mean the difference between arriving to a difficult entrance during daylight when it is safer to navigate, or later in darkness.
Increased travel time means increased exposure to changing weather conditions and the possibility of encountering foul weather.
Longer distances result in greater fuel consumption.
Overly conservative routing unnecessarily increases traffic in bottlenecks such as narrow channels, thus increasing the risk of collisions.

The problem is exacerbated in regions of large tidal ranges where the tide variation can amount to several times the vessel's draft. Nevertheless, navigating by the static color coding and low-tide, static depth values is often the default option for most boaters utilizing the now ubiquitous electronic chart-plotter. The real-time nature of chart-plotters unfortunately discourages the practice of traditional chart plotting and proper seamanship. In the age of video games, following the icon on the screen has become the de-facto form of navigating.

The proliferation of electronic chart-plotters nevertheless presents a unique opportunity to customize the once static nautical chart. The information can be tailored to take into account environmental conditions. In fact, modern chart-plotters have capabilities to overlay weather information, radar returns, satellite imagery, vessel traffic and other ancillary information such as crowd-sourced data to help the mariner navigate more safely and make better decisions. Private electronic chart data producers are including a growing list of ancillary chart data as layers in the digital chart image dataset. The manufacturers of ECDS equipment provide sophisticated graphical user interfaces to take advantage of these additional data sources. These units connect either to an external GPS receiver or have an integral receiver built in, to permit the vessel's position, speed and heading to be indicated on the digital chart as the vessel moves.

Electronic charts are classified into two types: raster and vector. The former is simply a scanned image of a paper chart. All depth information (spot soundings, contours, color-shading) as well as height clearances are rigidly cast as pixel color values in an image and not readily interpretable as depth or height values by a computer. The vector data type, in contrast, consists of data objects in a file that are interpreted by a computer program running on the ECDS. For example, depth values consist of a latitude and longitude coordinate and associated depth at Lowest Astronomical Tide. Contours are represented using line segments with vertices at specific coordinates, tagged for specific depths. Color shading is coded as polygons with color attributes. Because of the flexibility of this data format, a chart-plotter using vector charts has the capability to enable or disable the displaying of a certain class of features, or customize the color scheme used, for example. Because of this capability, vector-based electronic nautical charts have become the favored data type for use in chart-plotters.

Modern electronic chart-plotters now offer a feature whereby the chart information is presented in virtual three dimensions (a perspective view projected onto a two-dimensional view for display on the chart-plotter's screen). For this feature to be useful, the navigation software has access to higher resolution bathymetry than what is available in the government-issued ENC. Private companies are currently supplying this high-resolution bathymetry to feed the growing need for accurate modeling of the seabed.

The methods claimed here takes advantage of the object-oriented nature of vector-based electronic charts as well as the processing capability of modern chart-plotters and the availability of high-resolution datasets to provide a novel and useful presentation of navigational information. This will provide a vital tool for efficient and safe navigation of waterways affected by tide.

### DISCLOSURE

The development of the vector-based electronic nautical chart presents the opportunity to modify bathymetric data provided in the charts given tidal information for a region and vessel draft. This capability, combined with the unique display capabilities of the modern ECDS, or electronic chart-plotter, presents a further opportunity to compute updated bathymetry for displaying depth information in a more useful and intuitive way for the vessel operator. It is the object of this disclosure to describe the method for computing and generating customized nautical chart information using specifically vector-based chart data (ENCs and DNCs), and a modern ECDS or computer. The GPS position is only necessary while the vessel is underway. It is possible to use most features of this method without GPS position information while route planning to determine the feasibility of a route given charted depths along a track and operator-specified parameters for vessel draft, anticipated speed, and planned time of departure.

The method here disclosed, herein termed “tide-correction program,” can be implemented in a computer program running inside the ECDS/chart-plotter (the preferred embodiment) though it can also be run on any computer that is capable of interpreting electronic nautical charts. There are four main processing components of the tide-correction program, namely:
Regional Tide Estimation Algorithm,
Bathymetry Correction Calculator,
Derivative Product Generator,
ECDS Interface.

Optionally, in support of claims and , when the on-board depth-sounder readings are available to the ECDS via networking, an additional software component will monitor the depths and compare them against the current position's tide-corrected depth prediction.

Regional Tide Estimation Algorithm. This component accepts a geographic location (latitude, longitude) as well as a date and time to compute the estimated tide height relative to a chart datum for that location and time. The algorithm will have access to tide look-ups for nearby primary tide stations as well as time and height offsets for nearby secondary stations. This is normally available as a database inside of the ECDS, but can be included as part of the algorithm if necessary or from the internet if a connection is available. The algorithm will involve some form of weighted interpolation of surrounding tide station data. This part of the method can be implemented in varying levels of sophistication, from simple bilinear interpolation models (least accurate) to complex algorithms performing hydrodynamic modeling. One intermediate solution listed in claim 13, is the ability for the operator to define “tertiary” tide stations, i.e., locations where the tide time and height differences are known by the operator but are not part of the official list of primary and secondary stations provided in the tables. The precise algorithm chosen is not an object of this disclosure and only affects the accuracy of the derived tide-corrected product. That said, the development of an accurate tide prediction model will be a critical challenge to the acceptance of this technology for marine navigation. The mariner would still need to practice prudent navigation and understand the risks of using the technology.

Bathymetry Correction Calculator. This is the processing component of the tide-correction program responsible for ingesting an electronic nautical chart (ENC) within a specified area-of-interest, typically the area currently being displayed on the ECDS screen, and adjusting all depth and height values for specific dates and times. The calculator will search the input ENC dataset for objects containing a vertical measurement such as spot depths, supplementary dense measurement data (such as raw soundings and/or third-party high resolution bathymetry), and height clearances. The calculator can also reference the vessel's draft as entered by the operator. For each vertical measurement data object, the calculator will request a tide offset from the Tide Estimation Algorithm at some specified time (depending on the functionality being invoked) at that object's location. It will then add the tide offset to the measurement, and subtract the vessel's draft (if so instructed by the operator) to arrive at a new vertical measurement that it stores as a new object. The final result is a collection of vertical measurement data objects that are maintained in computer memory for use by the Derivative Product Generator and by the ECDS Interface.

The Bathymetry Correction Calculator would also implement the functionality of claim—“varying time chart.” given either real-time data from the GPS (location, heading and speed), or using data entered by the operator for route planning purposes.

Derivative Product Generator. This stage of the processing generates contour lines and depth color-shading according to the vertical measurement data objects computed in the previous step. Contour lines and color shading are represented digitally as data objects with particular attributes to completely define the feature geospatially (locations on Earth) and visually (color, line thickness, etc.). Contour lines and associated depth-dependent color-shading can be accomplished in a variety of ways using 3D surface modeling. The exact technique chosen is not an object of this invention as there are well-accepted methods in the public domain. One approach is to construct a polygon mesh with the locations of the vertical measurement data objects produced by the Bathymetry Correction Calculator as nodes in the mesh. The contours are then generated by mathematically intersecting horizontal planes at specified depths with the polygon mesh to arrive at a collection of line segments representing the contours. The depths chosen for the horizontal planes are specified either by the user or by some defaults in the ECDS controller or this program. It should be mentioned that some ECDS already generate the 3D surface models representing the ocean bottom. In that case, the program should try to utilize those datasets for performing the intersections, though the depths predicted by those models would need to be adjusted accordingly by the Bathymetry Correction Calculator.

The generation of the color-shaded regions would proceed in a similar fashion to the contour generation since contours define the limits of the color-shaded regions. The Product Generator would then proceed to close those polygons according to some accepted heuristic and assign fill-color attributes to the resulting closed polygon data objects. The polygons are then virtually layered so that the shallowest shows on top. The resulting polygon data objects for contours and color-shading are stored as new vector layers that are made available to the ECDS Interface for overlay on the display.

ECDS Interface. This component of the tide-correction program is responsible for communicating with the ECDS controller software. It presents the results of the previous components to the display system. This necessarily involves modification of the ECDS controller software since the latter would need to expose setup menus specific to tide-correction processing. The operator would access these menus to specify parameters like vessel draft, desired colors, route identifiers (for planning), etc.

The Interface will also expose to the ECDS the collection of tide-corrected data objects as computed by the Bathymetry Correction Calculator and the Derivative Products Generator. It would also include a software technique for providing communication between processes, to the ECDS controller so that any notifications to the operator (such as imminent grounding risk described in claim 11) can be broadcast to the ECDS controller software for displaying and sounding an alarm.

A detailed description of the Interface would necessarily depend on the ECDS equipment manufacturers who adopt this technology. The mention of this component in this disclosure is intended to illustrate the overall functioning of the computer program, and not claim any detail of the actual interface implementation. Each ECDS control software is different and interfaces would vary depending on the ECDS implementation.

Optional Depth Monitoring. This optional software component supports claims and , whereby the on-board depth-sounder readings are available to the ECDS via networking. This software component will monitor the depths as sensed by the depth-sounder (corrected to read relative to the water-line) and compare them against the current position's tide-corrected depth prediction as computed by the Bathymetry Correction Calculator. Statistics of differences are accumulated and available to the operator in assisting with establishing local tide differences (i.e., user-programmable tertiary tide stations). These running statistics can also be referenced automatically by this software component for reporting significant variations from predicted depths as a warning to the operator.

### PREFERRED EMBODIMENTS

Embedded. The most likely embodiment of the tide-correction method disclosed here is as binary software installed on the ECDS computer system. The main ECDS controlling software would interface to the tide-correction software via functions and data objects. The ECDS control software would support the functioning of the tide-correction software by providing the operator with setup menus and status messages. The ECDS would also support this functionality with methods of displaying the data generated by the tide-correction program. The operator would select which features of the method would be enabled and displayed, such as
spot soundings (the depth numbers displayed on the chart) corrected for tide at a particular time,
contour lines including their properties (intervals, specific depths, etc.)
color-shading including its properties (min depth accessible, color of inaccessible regions, caution range and color, etc.)
specification and enabling of warnings and alarms, and
any other property, parameter or attribute supporting the useful operation of the tide-correction software.

The tide-correction software would then process the original bathymetry, using the highest-resolution data available on the device or available online if the device is connected to the internet, and according to the settings input by the operator or defaulted by the ECDS. The software would then generate either a new electronic chart with tide-correction included for display on the ECDS, or communicate the updates to the ECDS for display as separate data layers on top of the original ENC.

Standalone. Another embodiment is for the tide-correction software disclosed here to be installed on a computer system that is not part of an on-board ECDS. The user would operate the software from a personal computer, electronic tablet or mobile phone for planning and research purposes. The functioning of the tide-correction software would proceed identical to the embedded configuration above. In fact, some ECDS configurations involve a personal computer working as a dedicated chart-plotter. In this instance, the embodiment is effectively identical to the embedded configuration.

Cloud-based. Yet another possible embodiment is for the tide-correction program to be hosted on an internet server computer (or cluster of computers) commonly referred to as “the cloud”. The operator would request a tide-corrected product via a client web browser or dedicated client program. The actual tide correction processing and derivative product generation would be performed by high performance servers for extremely fast processing. Then the results would be transmitted to the client computer for display and/or storage. As cellphone networks and satellite communication systems evolve, it is conceivable that the ECDS itself will maintain sufficient broadband internet connectivity to offload the tide-correction processing to the cloud, reducing the processor and memory requirements of the device and taking advantage of higher quality data sources available to the servers.

The preferred embodiments described above are not intended to limit or expand on the claims set forth herein. They merely serve to help clarify those claims and to suggest ways in which this technology can be made useful.

References Cited

U.S. Patent Documents:

| | | |
|---|---|---|
| 5,363,307 | November 1994 | Yoshida |
| 6,750,815 | June 2004 | Michaelson, et al. |
| 6,256,585 | July 2001 | Shannon |
| 6,317,079 | November 2001 | Shannon |
| 6,295,248 | September 2001 | Nakamura |
| 8,121,788 | February 2012 | Bordakov, et al. |

Field of Search 701/409, 701/538, 701/423

1. A method of updating the display of electronic nautical chart represented in vector format (ENCs) so that depths are available with the correction for tide applied. Existing electronic tide tables or computer program, accessible to the Electronic Chart Display System (ECDS)¹ for predicting tide, is referenced given a specific location, date and time, and this tide offset is applied to the depth values to arrive at an updated representation of the coastline and ocean floor for the region.
¹ Throughout this document, the use of the term “Electronic Chart Display System” (ECDS), and alternatively “chart-plotter”, shall refer to all electronic display systems used for rendering electronic nautical charts for navigation. There are generally two classes of these devices currently in use: (1) the Electronic Chart System (ECS) used primarily by recreational boaters and some professional mariners; though usually consisting of a dedicated display device, this may also consist of computing devices commonly used aboard such as laptops, tablets or smartphones, running specialized navigation software utilizing electronic charts, and (2) the Electronic Chart Display and Information System (ECDIS) commonly found on larger ships. The claims and subsequent information herein relate equally to both, and refer to both systems collectively as “ECDS” or alternatively as “chart-plotter.”

2. The method of claim 1, wherein the corrected depth values are used to generate an updated navigational chart with the spot depth readings reflecting the depths corrected for tide, i.e., the depths below actual sea level at any specified time-of-day.

3. The method of claim 1, wherein the displayed depth contours are generated using the depths corrected for tide. The depth contour intervals can be system defaults or programmed by the operator of the ECDS. This functionality will likely require a bathymetry database of higher resolution than that usually available in current government-supplied ENCs.

4. The method of claims 1 and 3, wherein the regions within a range of depths corrected for tide are color coded (i.e. translucent shading), as programmed by the operator of the ECDS, to provide an easily interpreted representation of the depths.

5. The method of claims 3 and 4, wherein the draft of the vessel is programmed and referenced for displaying depth contours and color coding. The result would be a navigational chart customized to the vessel's draft where depths, contours and/or shading represent depths below the vessel's keel.

6. The method of claims 3, 4, and 5, wherein the ECDS can continuously update the displayed tide-corrected (and draft-corrected if desired) depths, contours and color-shading using the current date and time.

7. Similar to claim 6, wherein the ECDS generates and displays bathymetric information corrected for tide (and vessel draft if desired) for any specified date and time in the past or the future for analysis and planning purposes.

8. Similar to claim 6, wherein the ECDS creates a “movie-loop” given a start and stop time and time scale. This movie loop will show the depth values, contours, and shading change with the ebbing and flooding of the tide.

9. A method for computing the tide offsets between primary and secondary tide stations in order to arrive at a best estimate of tide offset for any location to support the method of claim 1.

10. A customized graphical representation of depth information (i.e. depths, contours, and color-shading) according to above claims, with the additional functionality of applying variable tide corrections along a planned route (or radiating from the vessel's current position) using the vessel's speed and thus anticipated position to compute the corrected depth information along the vessel's path for the estimated time of arrival at each point along the route, so that the operator can more easily decide the feasibility of the route ahead of time. This functionality shall herein be termed “varying time chart.”

11. A method of reporting to the ECDS (and thus the operator) the presence or imminence of a grounding risk as determined by considering the vessel's draft and actual depths using tide-corrections per claim 1, and predicted ahead of time for the route per claim 10.

12. A method of correcting the vertical clearances of objects above sea level, such as bridges and power-lines, to reflect actual clearances for specific date and time.

13. A method to permit the operator (via the ECDS human interface) to define additional “tertiary” tide stations that can improve the interpolation accuracy of tide offsets (and thus corrected depths and heights) beyond that possible using solely the published primary and secondary tide stations.

14. A method to accept soundings from an on-board, networked depth-sounder to correlate against the tide-corrected predictions of claim 1 to monitor the accuracy of the localized tide predictions and generate accuracy statistics.

15. A method of alerting the vessel operator of significant differences between tide-corrected predictions of claim 1 and that being sensed by the on-board depth-sounder.

16. A method to permit reporting tide-corrected depths and programming desired contour and shading depths as claimed above in either metric or imperial units.
